(19) United States
(12) Patent Application Publication
(10) Pub. No.: US 2025/0091364 A1
(43) Pub. Date: Mar. 20, 2025

(54) PRINTING APPARATUS

(71) Applicant: CANON KABUSHIKI KAISHA, Tokyo (JP)

(72) Inventors: SHOICHI ZENSAI, Kanagawa (JP); KOICHI ITO, Tokyo (JP)

(21) Appl. No.: 18/884,382

(22) Filed: Sep. 13, 2024

(30) Foreign Application Priority Data
Sep. 15, 2023 (JP) 2023-150326

(51) Int. Cl. B41J 11/00; B41J 13/00; B41J 13/08; B41J 29/377

(52) U.S. Cl. CPC B41J 11/00222; B41J 13/0027; B41J 13/08; B41J 29/377

(57) ABSTRACT

A printing apparatus, including: at least one memory and at least one processor which function as: a conveyance unit configured to convey a printing media on which an image is printed by a printing unit; a detection unit configured to detect whether an anomalous module exists among a plurality of modules for drying the printing media conveyed by the conveyance unit; a control unit configured to execute either first control for controlling output from any normal module among the plurality of modules or second control for controlling conveyance speed of the printing media in a case where the detection unit detects that an anomalous module exists; and an obtainment unit obtain temperature to be set to the normal module in a case where the detection unit detects that an anomalous module exists.

### BACKGROUND OF THE INVENTION

### Field of the Invention

The present disclosure relates to technologies of printing images.

### Description of the Related Art

Japanese Patent Laid-Open No. 2011-224932 (Literature 1) discloses a method of drying ink applied to a surface of a printing sheet by using a dry unit including drying modules after printing in an ink jet printing apparatus.

According to the method of Literature 1, in a case where output from one of a plurality of drying modules has decreased, the printing apparatus is stopped and the drying module is replaced. Thus, the printing apparatus cannot be operated until the replacement of the drying module ends, and it is concerned that downtime occurs for a user. Similarly, in a case of a configuration including a plurality of modules that cool a printing sheet after drying, productivity for the user potentially decreases by stopping the printing apparatus when output from one of the modules has decreased.

### SUMMARY OF THE INVENTION

A printing apparatus according to an aspect of the present disclosure includes: at least one memory and at least one processor which function as: a conveyance unit configured to convey a printing media on which an image is printed by a printing unit; a detection unit configured to detect whether an anomalous module exists among a plurality of modules for drying the printing media conveyed by the conveyance unit; a control unit configured to execute either first control for controlling output from any normal module among the plurality of modules or second control for controlling conveyance speed of the printing media in a case where the detection unit detects that an anomalous module exists; and an obtainment unit configured to obtain temperature to be set to the normal module in a case where the detection unit detects that an anomalous module exists.

Further features of the present invention will become apparent from the following description of exemplary embodiments with reference to the attached drawings.

### BRIEF DESCRIPTION OF THE DRAWINGS

FIG. 1 is a schematic sectional view illustrating an example of the configuration of a printing apparatus;

FIG. 2 is a block diagram illustrating an example of the configuration of a control unit;

FIGS. 3A and 3B are diagrams illustrating an example of the configuration of a drying unit;

FIGS. 4A and 4B are diagrams illustrating an example of the configuration of a cooling unit;

FIGS. 5A and 5B are cross-sectional views illustrating an example of the configuration of the drying unit;

FIGS. 6A to 6C are diagrams illustrating an example of a case where output from a drying module has decreased;

FIG. 7 is a flowchart illustrating an example of processing executed by a printing apparatus;

FIG. 8 is a flowchart illustrating an example of processing executed by the printing apparatus;

FIG. 9 is a flowchart illustrating an example of processing executed by the printing apparatus;

FIG. 10 is a flowchart illustrating an example of processing executed by the printing apparatus;

FIGS. 11A to 11C are diagrams illustrating an example of a plurality of cooling modules disposed in a sheet width direction;

FIG. 12 is a flowchart illustrating an example of processing executed by the printing apparatus;

FIGS. 13A and 13B are diagrams illustrating an example of a plurality of drying modules disposed in the sheet width direction and processing executed by the printing apparatus;

FIG. 14 is a diagram illustrating an example of the configuration of the printing apparatus;

FIGS. 15A to 15C are diagrams illustrating an example of cooling units disposed in a thickness direction;

FIG. 16 is a flowchart illustrating an example of processing executed by the printing apparatus;

FIG. 17 is a flowchart illustrating an example of processing executed by the printing apparatus;

FIG. 18 is a diagram illustrating an example of a roll sheet on which a plurality of images are printed in a sheet width direction;

FIGS. 19A to 19C are diagrams illustrating an example of a plurality of modules disposed in the sheet width direction;

FIG. 20 is a flowchart illustrating an example of processing executed by the printing apparatus; and

FIG. 21 is a flowchart illustrating an example of processing executed by the printing apparatus.

### DESCRIPTION OF THE EMBODIMENTS

Preferable embodiments of the present disclosure will be specifically described below with reference to the accompanying drawings. Constituent components described below in the embodiments are merely exemplary, and the configuration of an apparatus to which the present disclosure is applied and various conditions may be modified and changed as appropriate without departing from the scope of the present disclosure. In other words, the embodiments below do not limit the present disclosure, and not all combinations of features described below in the embodiments are necessarily essential for means for solution of the present disclosure. For example, the dimensions, materials, shapes, and relative dispositions of components described below in the embodiments may be changed as appropriate in accordance with the configuration of the apparatus to which the present disclosure is applied and various conditions, and the present disclosure is not limited to the embodiments below unless otherwise stated. Any identical components are denoted by the same reference sign in the following description.

### First Embodiment

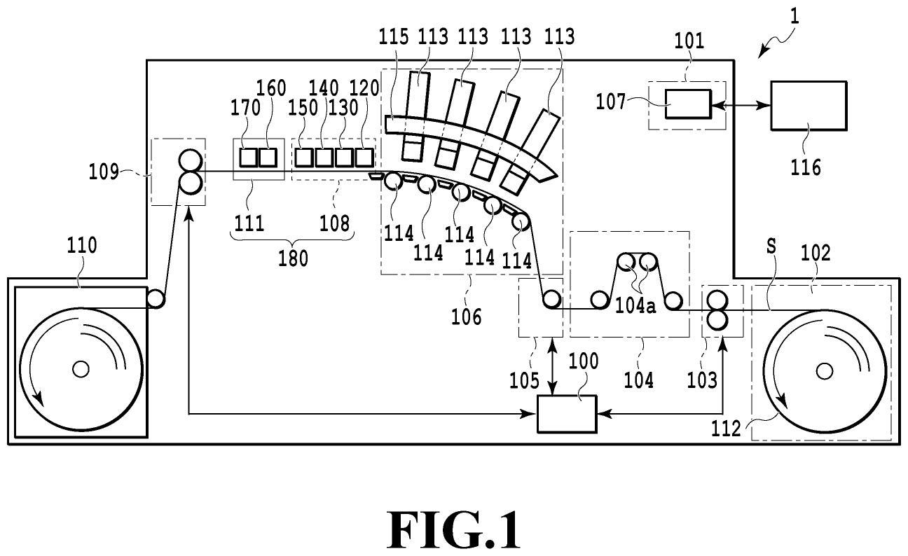

FIG. 1 is a schematic sectional view illustrating an example of the configuration of a printing apparatus 1 according to the present embodiment. The configuration of the printing apparatus 1 will be described below with reference to FIG. 1. First, the sheet upper side of FIG. 1 is defined as the upper side of the printing apparatus 1. The direction from right to left on the sheet of FIG. 1 is defined as a printing sheet conveyance direction. A direction orthogonal to the sheet of FIG. 1 is defined as a printing sheet width direction. The printing apparatus 1 in the present embodiment is a high-speed line printer using a continuous printing sheet wound in a roll shape. For example, the printing apparatus 1 is suitable for the field of mass printing in a print laboratory or the like.

The printing apparatus 1 in the present embodiment includes a control unit 101, a printing sheet supply unit 102, a first conveyance roller pair 103, a meandering correction unit 104, and a tension detection unit 105. The control unit 101 includes a printing unit 106, an operation unit 107, a drying unit 108, a second conveyance roller pair 109, a printing sheet collection unit 110, and a cooling unit 111. A continuous printing sheet (hereinafter referred to as a printing sheet) is conveyed along a printing sheet conveyance path illustrated with a solid line S in the drawing. The control unit 101 will be described later in detail.

The printing sheet supply unit 102 is a unit for holding a printing sheet and supplying the printing sheet. The printing sheet supply unit 102 is configured to house a roll 112 as a printing sheet wound in a roll shape and supply the printing sheet by pulling out. The number of rolls that can be housed in the printing sheet supply unit 102 is not limited to one. For example, the printing sheet supply unit 102 may be configured to house two or three or more rolls and supply a printing sheet by pulling out the printing sheet selectively. The present invention is not limited to a printing sheet wound in a roll shape as long as the printing sheet is continuous. For example, a printing sheet perforated at unit lengths and folded along the perforations to form a stack may be housed in the printing sheet supply unit 102.

The first conveyance roller pair 103 is a unit for feeding a printing sheet along the printing sheet conveyance path (solid line S) and applying printing sheet tension with the second conveyance roller pair 109 to be described later. The first conveyance roller pair 103 rotates as a non-illustrated motor is driven. Tension conveyance is achieved by the rotating first conveyance roller pair 103.

The meandering correction unit 104 is a unit for correcting meandering in the printing sheet width direction during tension conveyance of a printing sheet. The meandering correction unit 104 is configured to include a meandering correction roller 104a and a non-illustrated meandering sensing sensor that senses meandering of a printing sheet. The meandering correction roller 104a can be controlled by a non-illustrated motor to change tilt of the printing sheet in the printing sheet conveyance direction. Meandering correction of the printing sheet is performed by the meandering correction roller 104a controlled based on measurement by the meandering sensing sensor. In this case, the function of meandering correction can be enhanced as the printing sheet wraps around the meandering correction roller 104a. The tension detection unit 105 is a unit for detecting tension when tension conveyance is performed between the first conveyance roller pair 103 and the second conveyance roller pair 109.

The printing unit 106 includes printing heads 113, guide rollers 114, and a head holder 115. The printing unit 106 is a printing sheet processing unit that prints an image by performing printing processing on a conveyed printing sheet from above by the printing heads 113. A conveyance path in the printing unit 106 is formed by the guide rollers 114 disposed in an arc shape that is convex upward, and clearance from the printing heads 113 is ensured as constant tension is applied on a printing sheet. The printing heads 113 are disposed in an arc shape like the conveyance path. The printing unit 106 includes four linear type printing heads 113, corresponding to four colors of black (Bk), yellow (Y), magenta (M), and cyan (C). The number of colors and the number of printing heads 113 is not limited to four. The printing heads 113 are integrally held by the head holder 115. The head holder 115 can be operated in the up-down direction to change clearance between a printing sheet and the printing heads 113. For example, a scheme using a heat generation element, a scheme using a piezo element, a scheme using an electrostatic element, or a scheme using a MEMS element may be employed as an ink jet scheme. Ink of each color is supplied from a non-illustrated ink tank to the corresponding printing head 113 through an ink tube.

The operation unit 107 includes an operation key that receives an operation from a user and a liquid crystal display unit on which image data output from the control unit 101 is displayed. The operation key may be a hard key or a soft key. The liquid crystal display unit may have a touch panel function. The user can instruct control such as printing processing to the printing apparatus 1 by operating the operation unit 107.

The drying unit 108 is a unit for reducing a liquid content included in ink applied on a printing sheet by the printing unit 106 to increase fixation between the printing sheet and the ink. The drying unit 108 dries ink applied on a printed printing sheet. Inside the drying unit 108, heated air is applied to a passing printing sheet at least from the upper surface side to dry an ink applied surface. The scheme of applying heated air may be combined with a scheme of irradiating a printing sheet surface with electromagnetic waves (ultraviolet or infrared), or a conductive heat transfer scheme by contact with a heat generation body and applied as a drying scheme.

The cooling unit 111 is a unit that cools a printing sheet heated by the drying unit 108. With the cooling unit 111, it is possible to prevent heat storage in the roll and ink adhesion to a conveyance roller surface that contacts ink on the printing sheet in the printing sheet collection unit 110 to be described later. Inside the cooling unit 111, air is sent to the printing surface side of the printing sheet to cool the printing surface side. The cooling unit 111 is configured to blow air at desired wind speed to the printing sheet from the outside of the printing apparatus 1 through a non-illustrated duct by a fan or the like. The cooling unit 111 may be configured to blow air at temperature lower than the outside temperature of the printing apparatus 1 by using a heat exchanger. The drying unit 108 and the cooling unit 111 are collectively referred to as an air sending unit 180 because of their functions to send and apply air to the printing sheet irrespective of existence of heating.

The second conveyance roller pair 109 is a unit that conveys a printing sheet while applying tension together with the first conveyance roller pair 103 and adjusts tension of the printing sheet. The second conveyance roller pair 109 rotates as a non-illustrated motor is driven. Tension of the printing sheet is adjusted by a clutch (not illustrated) capable of controlling torque through drive coupling, which is will be described later, in accordance with a tension value detected by the tension detection unit 105 under control by a tension control unit 100. A configuration for controlling the speed of the second conveyance roller pair 109 by the tension detection unit 105 may be added as an additional configuration for adjusting tension of the printing sheet. In this case, two schemes of a torque control method of controlling a torque value transferred from the clutch and a speed control method of controlling the roller speed of the second conveyance roller pair 109 may be provided as tension control methods, and the tension control methods may be switched or simultaneously used in accordance with a purpose.

The printing sheet collection unit 110 is a unit for winding a printing sheet subjected to printing processing around a winding core. The number of rolls that can be collected is not limited to one. Specifically, the printing sheet collection unit 110 may be configured to include two or three or more winding cores and collect a printing sheet by selectively switching the winding cores. Depending on contents of fabrication processing after printing, the printing sheet collection unit 110 may be configured to cut the printing sheet by using a cutter and stack the cut printing sheet instead of being configured to wind the printing sheet around a winding core.

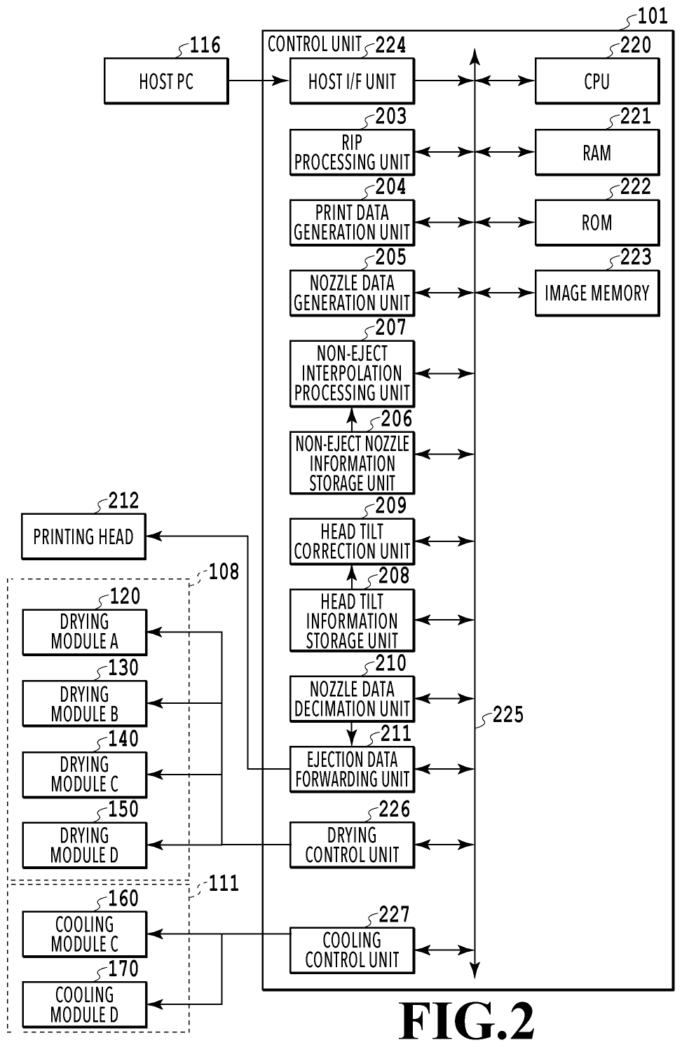

FIG. 2 is a block diagram illustrating an example of the configuration of the control unit 101 according to the present embodiment. The configuration of the control unit 101 will be described below with reference to FIG. 2. The control unit 101 is a unit that governs control of each component of the entire printing apparatus. The control unit 101 includes a central processing unit (CPU) 220, a random access memory (RAM) 221, and a read only memory (ROM) 222. The control unit 101 includes an image memory 223, a host interface (I/F) unit 224, a RIP processing unit 203, and a print data generation unit 204. The control unit 101 includes a nozzle data generation unit 205, a non-eject nozzle information storage unit 206, a non-eject interpolation processing unit 207, a head tilt information storage unit 208, and a head tilt correction unit 209. The control unit 101 includes a nozzle data decimation unit 210, an ejection data forwarding unit 211, a drying control unit 226, and a cooling control unit 227. These components including the CPU 220 are connected to a system bus 225.

The CPU 220 is a central processing unit, loads a computer program stored in the ROM 222 or the like onto the RAM 221, reads the computer program, and executes various kinds of control on each component, which will be described later. The RAM 221 is a main storage memory of the CPU 220 and used as a temporary storage region for loading a computer program stored in the ROM 222 or the like. A control program stored in the ROM 222 includes an OS for performing time-division control on load module units, referred to as multiples, based on a system clock. The image memory 223 stores, for example, nozzle data to be described later.

The host I/F unit 224 connects a host PC 116 and the control unit 101. For example, printing data and control instructions are input to the control unit 101 from the host PC 116 through the host I/F unit 224. The user can instruct control such as printing processing to the printing apparatus 1 by operating the host PC 116. The input printing data is rendered and is converted to multiple-value bit map data by the RIP processing unit 203. The input printing data is configured by, for example, a page description language (PDL). The multiple-value bit map data is subjected to ink color conversion and quantization processing at the print data generation unit 204 and set as halftone data of ink colors. The halftone data of each color is allocated to a nozzle by the nozzle data generation unit 205 and set as nozzle data (binary data) in the number of nozzles for each line. The nozzle data is subjected to non-eject interpolation processing (processing of reallocating ejection data allocated to non-eject nozzles to nozzles other than the non-eject nozzles) by the non-eject interpolation processing unit 207 in accordance with non-eject nozzle information stored in the non-eject nozzle information storage unit 206. The nozzle data subjected to the non-eject interpolation processing is subjected to head tilt correction (correction of moving data in the conveyance direction in accordance with a tilt amount) by the head tilt correction unit 209 in accordance with head tilt information stored in the head tilt information storage unit 208. The nozzle data subjected to the head tilt correction in this manner is stored in the image memory 223. The nozzle data stored in the image memory 223 is forwarded to the nozzle data decimation unit 210. The nozzle data subjected to the tilt correction and forwarded is subjected to decimation processing by the nozzle data decimation unit 210 and forwarded to a printing head 212 by the ejection data forwarding unit 211.

The control unit 101 performs, for example, temperature control of a drying module A 120, a drying module B 130, a drying module C 140, and a drying module D 150 included in the drying control unit 226. The control unit 101 can determine whether each drying module is normal based on polling to the drying module or feedback of normal temperature. The control unit 101 performs, for example, rotation speed control of fans of a cooling module A160 and a cooling module B170 included in the cooling control unit 227. The control unit 101 can determine whether each fan is normally rotating by using a non-illustrated encoder unit in the fan or a sensing mean that senses lock (rotation defect) of the fan.

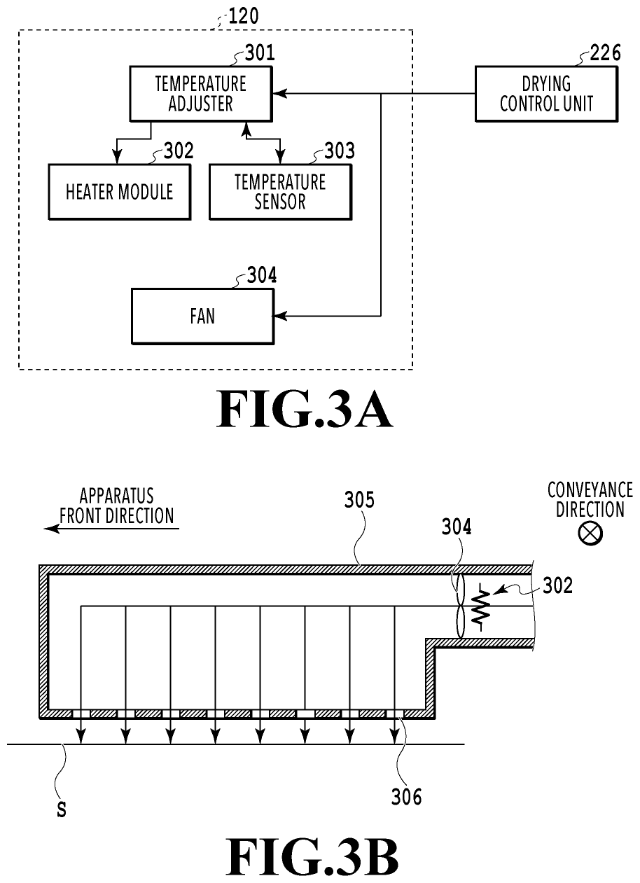

The configuration of the drying module A 120 will be described below with reference to FIGS. 3A and 3B. FIG. 3A is a diagram illustrating an example of the internal configuration of the drying module 120. The drying module 120 includes a temperature adjuster 301, a heater module 302 as a heating unit, a temperature sensor 303, and an air sending fan 304 (hereinafter referred to as a fan) that sends hot air. The temperature adjuster 301 receives information of a target temperature from the drying control unit 226. The temperature adjuster 301 controls on and off of the heater module 302 based on measurement data of temperature inside the heater module 302, which is output from the temperature sensor 303. However, the temperature adjuster 301 performs control to repeat on and off of the heater module 302 in accordance with a DUTY ratio instead of either on or off. For example, in a case where the target temperature is 70° C., the temperature adjuster 301 controls the DUTY ratio to, for example, 100% to increase the temperature of the heater module 302 when having obtained temperature measurement data indicating that the temperature inside the heater module 302 is 60° C. from the temperature sensor 303. This value is merely exemplary and variable.

FIG. 3B is a schematic sectional view illustrating an example of the drying module A 120 when viewed in the sheet conveyance direction. The configuration of the drying module A 120 will be described below with reference to FIG. 3B. The drying module A 120 includes an air path formed of a duct 305. The heater module 302 and the fan 304 are provided in the air path. The fan 304 sends air heated by the heater module 302 (hereinafter referred to as a heater) in the direction of the arrow in the drawing. Then, the sent air is blown to a printing sheet on the conveyance path S through nozzle parts 306 formed at an outer peripheral surface of the drying module 120 on the printing sheet side.

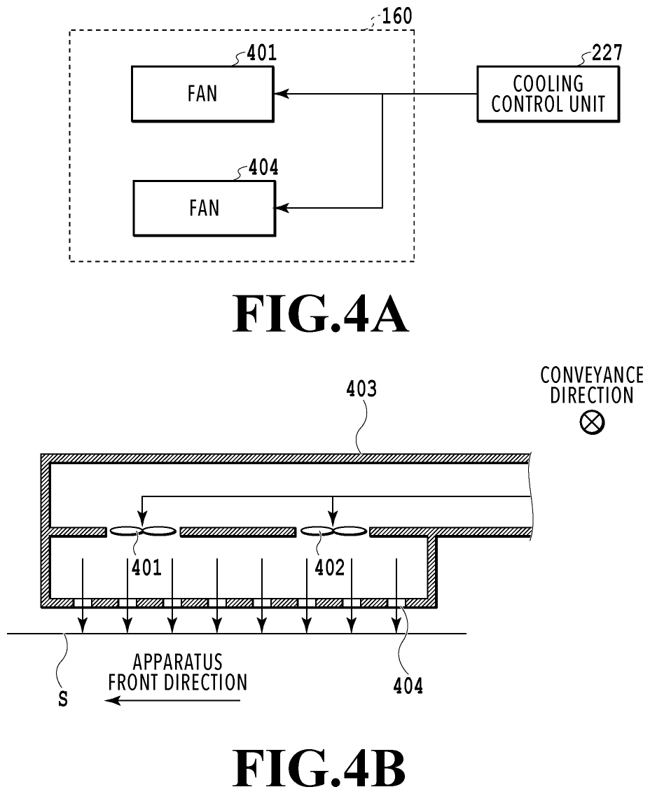

The configuration of the cooling module A 160 will be described below with reference to FIGS. 4A and 4B. FIG. 4A is a diagram illustrating an example of the internal configuration of the cooling module 160. The cooling module 160 includes fans 401 and 402. The control unit 101 controls the rotation speeds of the fans 401 and 402 through the cooling control unit 227. FIG. 4B is a schematic sectional view illustrating an example of the cooling module 160 when viewed in the sheet conveyance direction. The fans 401 and 402 are provided in an air path formed of a duct 403. The fans 401 and 402 send air in the direction of the arrow in the drawing. Then, the sent air is blown to a printing sheet on the conveyance path S through nozzle parts 404 formed at an outer peripheral surface of the cooling module 160 on the printing sheet side.

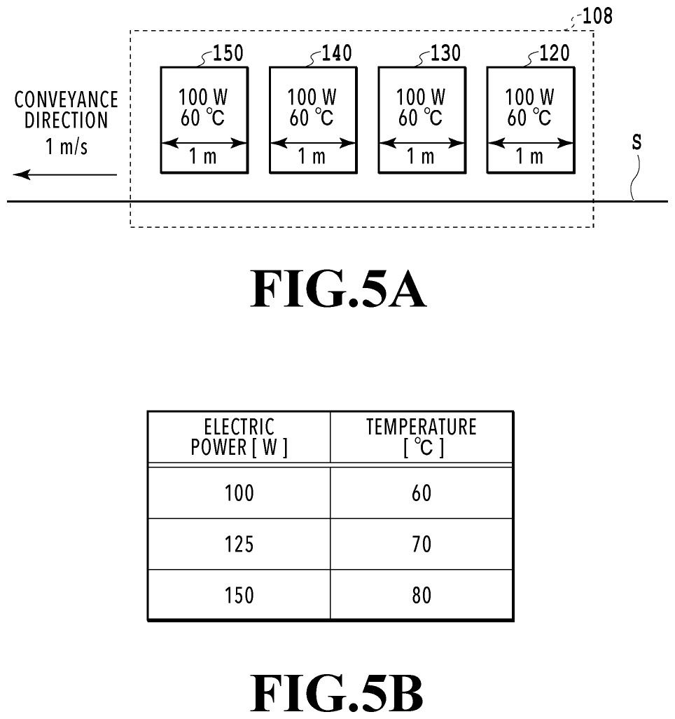

FIG. 5A is a cross-sectional view illustrating an example of the drying unit 108 when viewed in a front direction (hereinafter referred to as an apparatus front direction) of the printing apparatus 1. The drying unit 108 will be described below with reference to FIG. 5A. In FIG. 5A, a printing sheet is conveyed in the printing the sheet conveyance direction through the printing sheet conveyance path (solid line S). At that time, the printing sheet passes inside the drying unit 108. The drying modules A 120, B 130, C 140, and D 150 provided inside the drying unit 108 dry the ink applied surface of the passing printing sheet by applying heated air to the upper surface side of the printing sheet. In the present embodiment, each drying module has heater electric power set to 100 [W (watt)] and has a module width of 1 [m] when viewed in the apparatus front direction as illustrated in FIG. 5A. Setting information includes a heater target temperature of 60 [° C.] and a printing sheet conveyance speed of 1 [m/s]. The heater electric power of each drying module, the width of each drying module, the heater target temperature, and the printing sheet conveyance speed are not limited thereto but may be changed values. In the present embodiment, for example, the heat amount of 400 [J (joule)] is needed to dry ink applied onto a printing sheet. Accordingly, a total heat amount of 400 [J] is supplied to a conveyed printing sheet. The amount of heat for drying ink differs depending on a printing sheet and is a variable value.

FIG. 5B is a diagram illustrating an example of the correspondence relation between electric power supplied to each drying module and the temperature of the drying module. For example, the temperature of the drying module is 60 [C] in a case where the supplied electric power is 100 [W]. The temperature is 80 [° C.] in a case where the electric power is 150 [W]. These relation values of the electric power and the temperature are exemplary and variable values that vary depending on the heater material and the like.

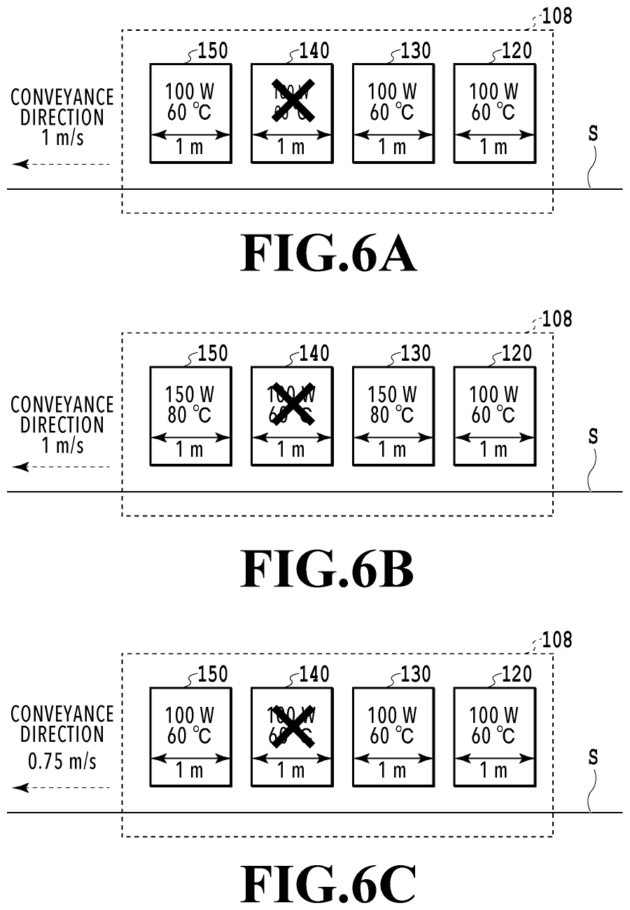

FIG. 6A is a cross-sectional view illustrating an example of the drying unit 108 when viewed in the apparatus front direction in a case where output from the drying module 140 has decreased. FIG. 6B is a diagram illustrating an example of a case where the electric power and temperature (hereinafter referred to as electric power/temperature) of the drying modules 130 and 150 are increased in FIG. 6A. FIG. 6C is a diagram illustrating an example of a case where the printing sheet conveyance speed is decreased in FIG. 6A. Control executed by the control unit 101 in a case where output from a drying module has decreased will be described below with reference to FIGS. 6A to 6C.

In the present embodiment, a case where there is no output from the drying module 140 will be described as an example. As illustrated in FIG. 6A, the drying modules 120, 130, and 150 are each supplied with electric power of 100 [W] and normally operating. Specifically, the three normal drying modules generate a heat amount of 3×100 [W]×1 [s (second)]=300 [J]. However, since there is no output from the drying module 140, 100 [W]×1 [s]=100 [J] is insufficient to reach the heat amount of 400 [J], which is necessary for drying ink. As illustrated in FIG. 6B, for example, the CPU 220 of the control unit 101 performs control for increasing the electric power/temperature of the drying modules 130 and 150 (neighboring modules to be described later) to compensate the insufficient heat amount. In the present embodiment, for example, the insufficient heat amount of 100 [J] is compensated by increasing the electric power of the drying modules 130 and 150 to 150 [W].

A method of electric power calculation will be described below. The heat amount, the electric power, and time are expressed as:

$$Heat amount [ J ] = Electric power [ W ] \times Time [ s ] . \qquad ( 1 )$$

In a case where the insufficient heat amount of 100 [J] is compensated by the drying modules 130 and 150, increase of 50 [J] is needed for each drying module. A passing time in which a printing media at the conveyance speed of 1 [m/s] passes through a drying module with the module width of 1 [m] is 1 [s]. Thus, according to Expression (1) described above, electric power of 50 [W] needs to be increased to compensate the insufficient heat amount of 50 [J] with one drying module. In other words, the electric power of each of the drying modules 130 and 150 needs to be 100 [W]+50 [W]=150 [W]. In addition, it can be understood from FIG. 5B that the temperature of each drying module is 80 [° C.] in a case where the electric power is 150 [W]. Thus, the CPU 220 of the control unit 101 performs control for increasing the electric power and temperature of each of the drying modules 130 and 150 to the above-described values.

Control for decreasing the printing sheet conveyance speed will be described next. To compensate the insufficient heat amount of 100 [J], it is needed generate the heat amount of 400 [J] necessary for drying ink with the total electric power of 300 [W] of normally operating drying modules in the drying unit 108. For this, in the present embodiment, the CPU 220 of the control unit 101 can perform control for decreasing the printing sheet conveyance speed as illustrated in FIG. 6C.

A method of conveyance speed calculation will be described below. In a case where the necessary heat amount of 400 [J] is generated by the three normal drying modules 120, 130, and 150, a heat amount to be generated by each drying module is obtained by dividing 400 [J] by three. Specifically, according to Expression (1) described above, a printing sheet needs to pass through each drying module with electric power of 100 [W] in the time of 4/3 (value obtained by dividing four by three) [s]. Accordingly, 0.75 [m/s] is obtained as the printing sheet conveyance speed.

In the present embodiment, a case where output from a drying module has decreased is described above with a case where there is no output from the drying module 140 (output is zero) as an example, but is not limited thereto. For example, the present invention is also applicable to a drying module not reaching target temperature or target electric power. In a case where output from a drying module has decreased, the control unit 101 performs control for increasing the electric power/temperature of any drying module neighboring the drying module with the decreased output or decreasing the conveyance speed. However, upper temperature limit is different depending on the kind of a conveyed printing sheet. For example, the upper temperature limit is 100 [° C.] in a case of paper and 70 [° C.] in a case of film. Accordingly, the temperature of a drying module can be increased in a case where the printing sheet is paper, but the temperature of a drying module cannot be increased because of the upper temperature limit in a case where the printing sheet is a film. Thus, control for decreasing the conveyance speed is employed as described above with reference to FIG. 6C. Determination of which control is to be employed is performed by the CPU 220 of the control unit 101.

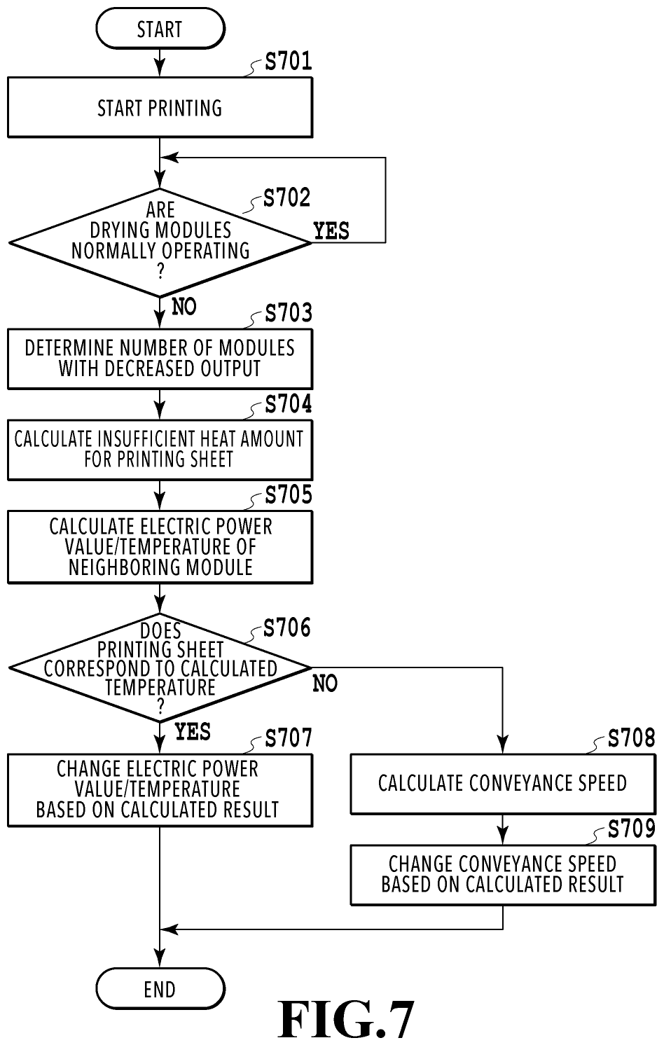

FIG. 7 is a flowchart illustrating an example of processing executed by the control unit 101 of the printing apparatus 1 according to the present embodiment. Control in a case where output from a drying module has decreased will be described below with reference to FIG. 7. The processing illustrated in FIG. 7 is achieved as the CPU 220 of the control unit 101 reads a computer program stored in the ROM 222 or the like onto the RAM 221 and executes the computer program. Functions of some or all steps in FIG. 7 may be achieved by hardware such as an ASIC or an electronic circuit. The symbol “S” in description of each processing means a step in the flowchart diagram (this is the same for the following flowchart diagrams in the present specification).

At S701, the CPU 220 starts printing. Thereafter, the CPU 220 proceeds to processing at S702. At S702, the CPU 220 determines whether the drying modules are normally operating. The CPU 220 proceeds to processing at S702 in a case of having determined that the drying modules are normally operating (Yes), or proceeds to processing at S703 in a case of having determined otherwise (No). In other words, the CPU 220 continues processing at S702 until determining that any drying module is not normally operating.

At S703, the CPU 220 determines the number of drying modules not normally operating. For example, in a case where output from any drying module has decreased, the CPU 220 determines the number of drying modules with decreased output. Thereafter, the CPU 220 proceeds to processing at S704. At S704, the CPU 220 calculates an insufficient heat amount from a heat amount necessary for drying ink on a printing sheet based on the number of drying modules with decreased output as described above with respect to FIGS. 6A to 6C. Thereafter, the CPU 220 proceeds to processing at S705. At S705, the CPU 220 calculates the electric power value/temperature of any neighboring module of a drying module to compensate the insufficient heat amount as described above with reference to FIG. 6B. Thereafter, the CPU 220 proceeds to processing at S706. In the above-described example, the neighboring modules are normal modules next to a drying module with decreased output as illustrated in FIG. 6B. Specifically, in a case where output from the drying module 140 has decreased, the neighboring modules are the drying modules 130 and 150 but not limited thereto. For example, the neighboring modules may be normal drying modules located two or more drying modules away from a drying module with decreased output, depending on the number and disposition of drying modules and the like.

At S706, the CPU 220 determines whether the printing sheet corresponds to the temperature calculated at S705. Specifically, the CPU 220 determines whether the temperature calculated at S705 is lower than the upper temperature limit of the printing sheet. The CPU 220 proceeds to processing at S707 in a case of having determined that the temperature calculated at S705 is lower than the upper temperature limit of the printing sheet (Yes), or proceeds to processing at S708 in a case of having determined that the temperature calculated at S705 is equal to or higher than the upper temperature limit of the printing sheet (No). At S707, the CPU 220 changes electric power value/temperature set to the drying module based on the result calculated at S705, controls the drying module through the drying control unit 226, and then ends the present processing.

At S708, the CPU 220 calculates the printing sheet conveyance speed to compensate the insufficient heat amount as described above with reference to FIG. 6C. Thereafter, the CPU 220 proceeds to processing at S709. At S709, the CPU 220 changes the conveyance speed based on the result calculated at S708. The CPU 220 controls the first conveyance roller pair 103 and the second conveyance roller pair 109 so that the printing sheet is conveyed at the changed conveyance speed, and then ends the present processing.

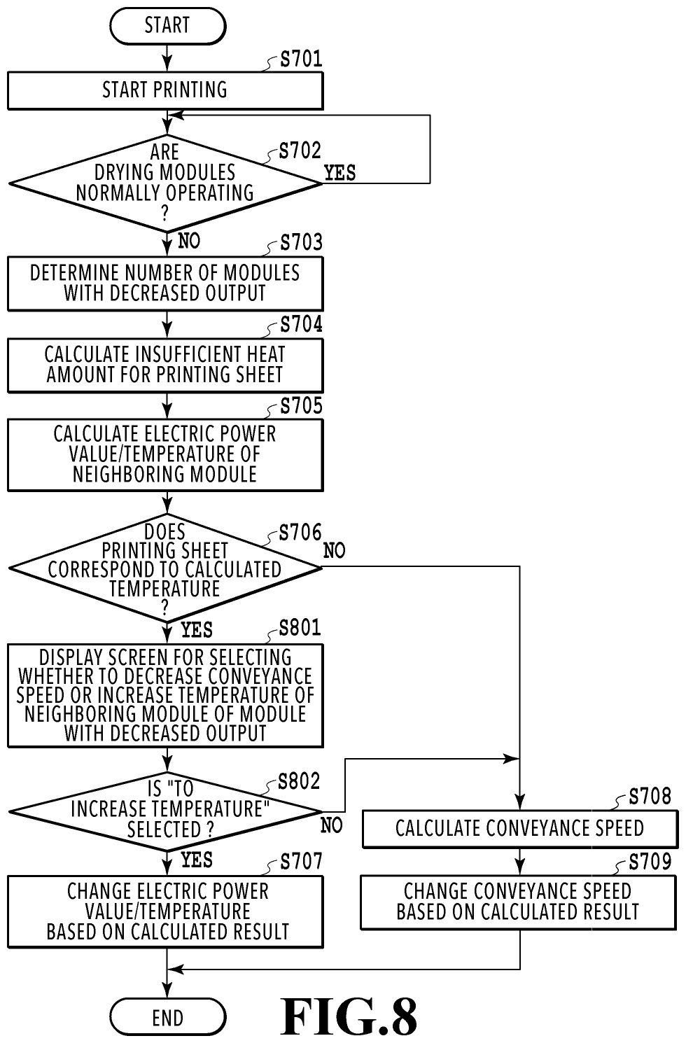

FIG. 8 is a flowchart illustrating a modification of the processing in FIG. 7. Control in a case where a process of selecting whether to decrease the printing sheet conveyance speed or increase the temperature of any neighboring module is added to the processing in FIG. 7 will be described below with reference to FIG. 8 with its difference from FIG. 7. Processing at S701 to S709 in FIG. 8 is the same as the processing described above with reference to FIG. 7, and thus description thereof is omitted.

At S801, the CPU 220 performs, on the operation unit 107, a display for selecting whether to decrease the printing sheet conveyance speed or increase the electric power value/temperature of any neighboring module of a drying module with decreased output. Then, the user selects to decrease the conveyance speed or increase the electric power value/temperature of the neighboring module. Thereafter, the CPU 220 proceeds to processing at S802.

At S802, the CPU 220 determines whether “to increase the electric power value/temperature of the neighboring module” is selected. The CPU 220 proceeds to processing at S707 in a case of having determined that “to increase the electric power value/temperature of the neighboring module” is selected (Yes), or proceeds to processing at S708 in a case of having determined that “to decrease the conveyance speed” is selected (No).

As described with reference to FIG. 7, in a case where output from a drying module has decreased, the printing apparatus in the present embodiment calculates the electric power value/temperature of any neighboring module and performs control for compensating insufficient output with the upper temperature limit of the printing sheet taken into account. Specifically, control for increasing the electric power value/temperature of the neighboring module or decreasing the printing sheet conveyance speed is performed. Accordingly, it is possible to prevent degradation of the image quality of an image printed on the printing sheet due to decreased output from the drying module and continue operation without stopping operation of the printing apparatus.

In the printing apparatus in the present embodiment, a conveyed continuous printing media is processed through continuous processes of printing, dry, and cooling. Accordingly, as the conveyance speed is decreased, the speed of printing processing is equivalently decreased. As described with reference to FIG. 7, control for increasing the electric power value/temperature of the neighboring module without decreasing the conveyance speed is performed in an allowable range of the upper temperature limit of a printing sheet, and thus the printing speed can be maintained.

According to the present embodiment, it is possible to prevent productivity degradation while excellently maintaining the image quality of the printing apparatus even in a case where output from a drying module has decreased. Moreover, as described with reference to FIG. 8, in a case where output from a drying module has decreased, the printing apparatus in the present embodiment receives, through an operation by the user, whether to increase the electric power value/temperature of the neighboring module or decrease the printing sheet conveyance speed. Thus, it is possible to achieve control with determination by the user taken into account.

### Second Embodiment

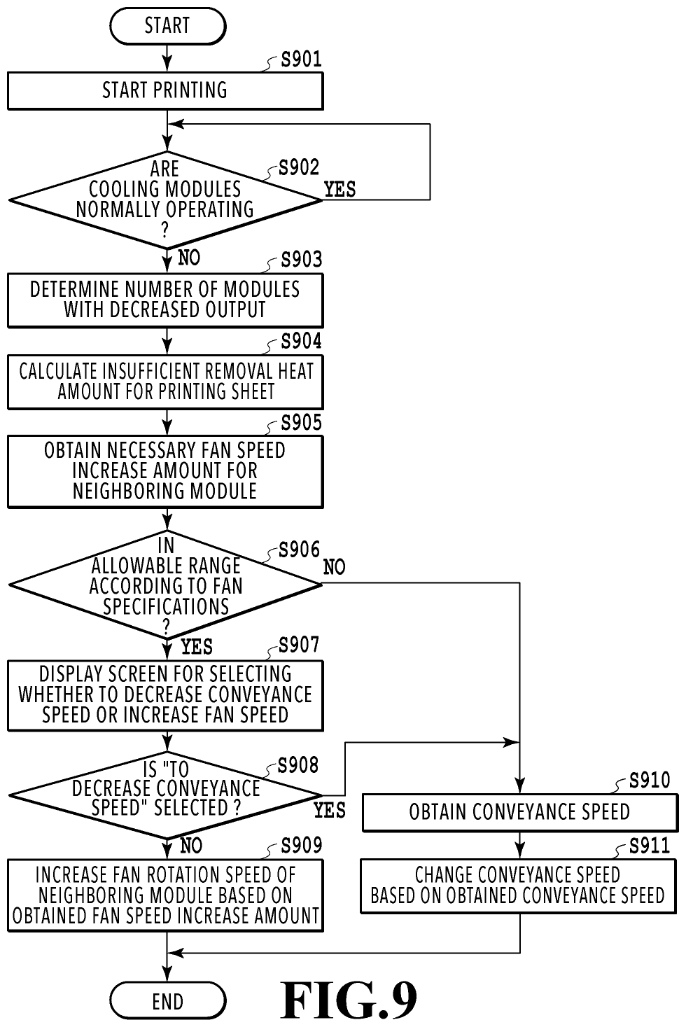

A second embodiment will be described next. The entire configuration of the printing apparatus 1 is the same as in the first embodiment and thus cited in the following description. Any component same as in the first embodiment is denoted by the same reference sign in drawings and description thereof is omitted as appropriate. The above description of the first embodiment is made on control for decreasing the printing sheet conveyance speed or increasing the electric power value/temperature of any neighboring module of a drying module with decreased output in a case where output from the drying module has decreased. The following description of the present embodiment will be made on control executed by the control unit 101 in a case where output from a cooling module has decreased in the cooling unit 111 of the printing apparatus 1 illustrated in FIG. 1. FIG. 9 is a flowchart illustrating an example of processing executed by the control unit 101 of the printing apparatus 1 according to the present embodiment. The processing illustrated in FIG. 9 is achieved as the CPU 220 of the control unit 101 reads a computer program stored in the ROM 222 or the like onto the RAM 221.

At S901, the CPU 220 starts printing. Thereafter, the CPU 220 proceeds to processing at S902. At S902, the CPU 220 determines whether the cooling modules are normally operating. The CPU 220 proceeds to processing at S902 in a case of having determined that the cooling modules are normally operating (Yes), or proceeds to processing at S903 in a case of having determined otherwise (No). In other words, the CPU 220 continues processing at S902 until determining that any cooling module is not normally operating.

At S903, the CPU 220 determines the number of cooling modules not normally operating and detected at S902. For example, in a case where output from any cooling module has decreased, the CPU 220 determines the number of cooling modules with decreased output. Thereafter, the CPU 220 proceeds to processing at S904. At S904, the CPU 220 calculates an insufficient heat amount to be removed (hereinafter referred to as an insufficient removal heat amount) based on the number of cooling modules with decreased output. For example, the insufficient removal heat amount can be calculated by subtracting a heat amount that can be removed by the cooling modules in the current state from the amount of heat applied by the drying modules, but the calculation is not limited to this method. Thereafter, the CPU 220 proceeds to processing at S905.

At S905, the CPU 220 obtains a necessary speed increase amount for the fan of each neighboring module of any cooling module. In the present embodiment, an example in which the speed increase amount is the rotation speed of the fan to be increased to compensate the insufficient removal heat amount will be described below. The CPU 220 obtains the speed increase amount of the fan from a known theoretical formula, a table for obtaining a predetermined parameter, an actual value output from a sensor, or combination thereof. As another configuration, for example, a thermometer that measures the temperature of the printing sheet in a non-contact manner may be installed after the cooling unit 111, and the speed increase amount of the fan may be obtained by feedback-controlling the rotation speed of the fan based on temperature data output from the thermometer. Explanation of neighboring modules is the same as described above.

At S906, the CPU 220 determines whether the fan rotation speed increased based on the speed increase amount obtained at S905 is in an allowable range according to specifications of the fan. In other words, the CPU 220 determines whether the increased fan rotation speed is a rotation speed according to specifications. The CPU 220 proceeds to processing at S907 in a case of having determined that the CPU 220 is in an allowable range according to specifications of the fan (Yes), or proceeds to processing at S910 in a case of having determined otherwise (No).

At S907, the CPU 220 performs, on the operation unit 107, a display for selecting whether to decrease the printing sheet conveyance speed or increase the fan speed. Then, the user selects to decrease the conveyance speed or increase the fan speed. Thereafter, the CPU 220 proceeds to processing at S908. At S908, the CPU 220 determines whether “to decrease the printing sheet conveyance speed” is selected. The CPU 220 proceeds to processing at S910 in a case of having determined that “to decrease the printing sheet conveyance speed” is selected (Yes), or proceeds to processing at S909 in a case of having determined otherwise (No).

At S909, the CPU 220 increases the fan rotation speed of each neighboring module of any cooling module with decreased output based on the fan speed increase amount obtained at S905, and then ends the present processing. At S910, the CPU 220 obtains the printing sheet conveyance speed. For example, the conveyance speed may be obtained from the theoretical formula, the table, or the like described above at S905. Thereafter, the CPU 220 proceeds to processing at S911. At S911, the CPU 220 changes the printing sheet conveyance speed based on the conveyance speed obtained at S910, and then ends the present processing. Although the two cooling modules 160 and 170 are disposed in the conveyance direction in the configuration of the printing apparatus 1 illustrated in FIG. 1, the present invention is not limited to two cooling modules but the same effects can be obtained even in a case where a plurality of cooling modules are provided.

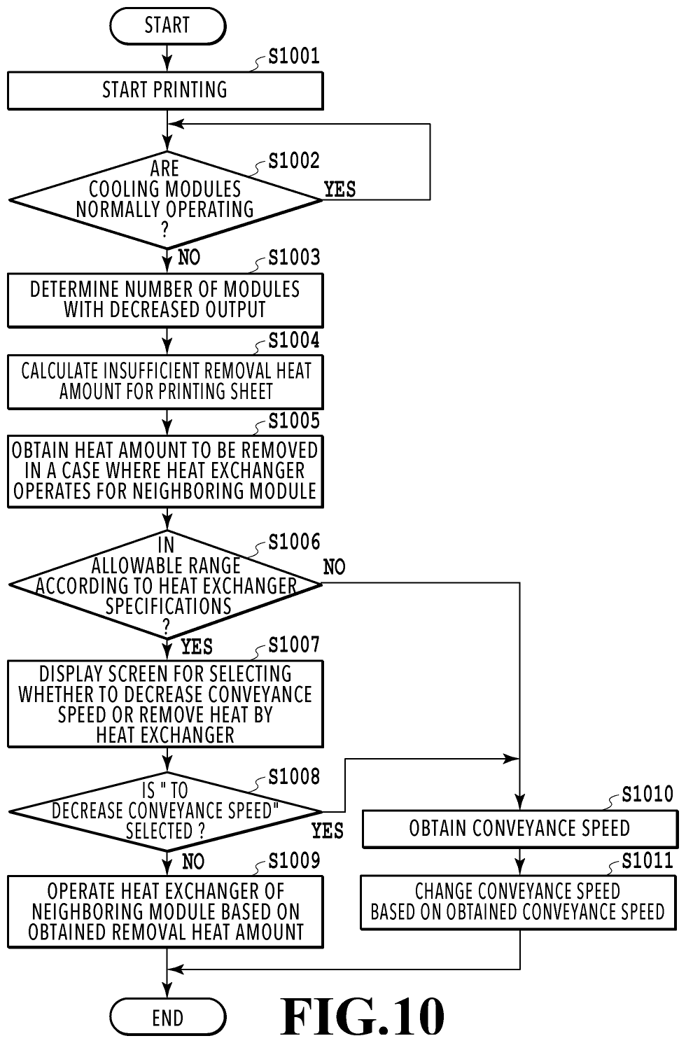

The above description with reference to FIG. 9 is made on processing of enabling continuation of production by increasing the fan rotation speed or decreasing the conveyance speed. The following description will be made on processing of adjusting air temperature by cooling air taken into each cooling module by using a non-illustrated heat exchanger to improve heat removal capability. FIG. 10 is a flowchart illustrating an example of processing executed by the control unit 101 of the printing apparatus 1 according to the present embodiment. Processing executed by the control unit 101 in a case where output from any cooling module has decreased will be described below with reference to FIG. 10. Processing at S1001 to S1004, S1010, and S1011 is the same as processing at S901 to S904, S910, and S911, respectively, and thus description thereof is omitted.

At S1005, the CPU 220 obtains a heat amount to be removed in a case where the heat exchanger operates (hereinafter referred to as a removal heat amount) for each neighboring module of any cooling module with decreased output. The CPU 220 obtains the removal heat amount from a theoretical formula, a table, an actual value output from a sensor, or combination thereof. Thereafter, the CPU 220 proceeds to processing at S1006. At S1006, the CPU 220 determines whether a setting value of the heat exchanger used to obtain the removal heat amount at S1005 is in an allowable range according to specifications of the heat exchanger. The CPU 220 proceeds to processing at S1007 in a case of having determined that the setting value is in an allowable range according to specifications of the heat exchanger (Yes), or proceeds to processing at S1010 in a case of having determined otherwise (No).

At S1007, the CPU 220 performs, on the operation unit 107, a display for selecting whether to decrease the printing sheet conveyance speed or remove heat by the heat exchanger. Then, the user selects to decrease the conveyance speed or remove heat by the heat exchanger. Thereafter, the CPU 220 proceeds to processing at S1008.

At S1008, the CPU 220 determines whether “to decrease the printing sheet conveyance speed” is selected at S1007. The CPU 220 proceeds to processing at S1010 in a case of having determined that “to decrease the printing sheet conveyance speed” is selected (Yes), or proceeds to processing at S1009 in a case of having determined otherwise (No). At S1009, the CPU 220 operates the heat exchanger of each neighboring module of the cooling module with decreased output based on the removal heat amount of the heat exchanger, which is obtained at S1005, and then ends the present processing.

According to the present embodiment, it is also possible to prevent productivity degradation while excellently maintaining the image quality of the printing apparatus even in a case where output from any cooling module has decreased.

### Third Embodiment

A third embodiment will be described next. The entire configuration of the printing apparatus 1 is the same as in the first and second embodiments and thus cited in the following description. Any component same as in the first and second embodiments is denoted by the same reference sign in drawings and description thereof is omitted as appropriate.

The above description of the first embodiment is made on control for decreasing the printing sheet conveyance speed or increasing the electric power value/temperature of each neighboring module in a case where a plurality of modules are arranged in the sheet conveyance direction. The following description of the present embodiment will be made on control in a case where a plurality of modules are arranged in the sheet width direction.

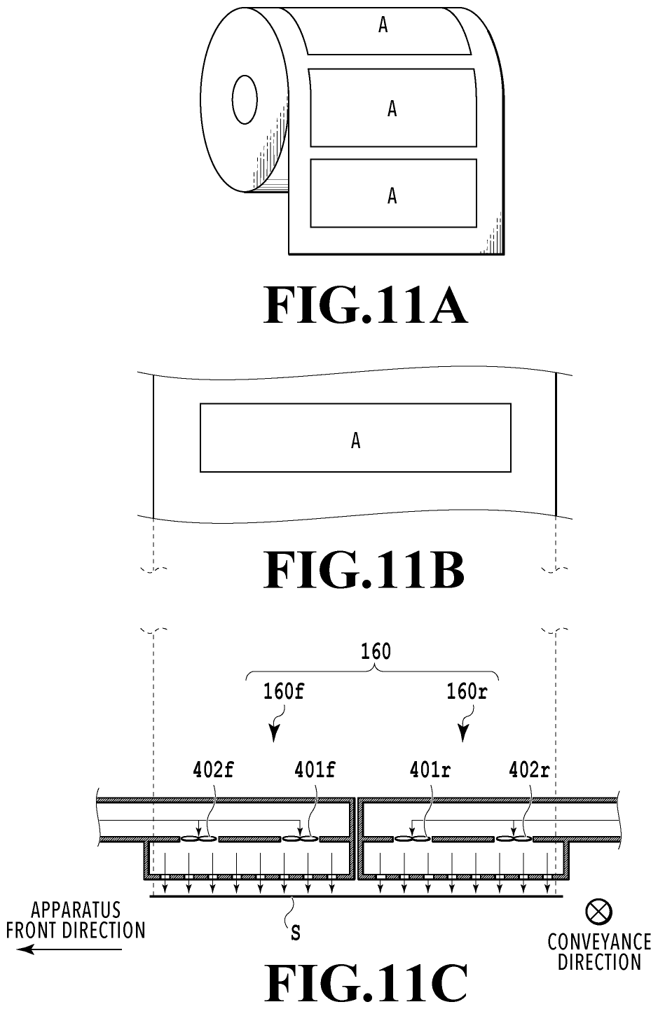

FIGS. 11A to 11C is a diagram illustrating an example of the relation between an image printed on a printing sheet and cooling modules. FIG. 11A is a diagram illustrating an example of the printing sheet on which images “(rectangle) A” having a size close to the printing sheet width are each disposed in the sheet width direction within the width of the printing sheet. FIG. 11B is a diagram illustrating an example of a case where a rectangular image (part denoted by “A”) mostly occupies the printing sheet in the sheet width direction. The fans 401 and 402 of the cooling module 160 described above with reference to FIG. 4B are disposed in the sheet width direction, and thus in a case where output from any one of them has decreased and stopped, an image corresponding to the other is cooled earlier. This potentially causes color unevenness of a large image extending in the sheet width direction. Thus, in a case where a plurality of fans are disposed in the sheet width direction like the fans 401 and 402, it is needed to stop the plurality of fans arrayed in the sheet width direction, including those with output not decreased, to excellently maintain the image quality. FIG. 11C is a schematic sectional view illustrating an example in which two cooling modules 160 are disposed in the sheet width direction. A cooling module 160r and a cooling module 160f include fans 401r and 402r and fans 401f and 402f, respectively. In FIG. 11C, the cooling module 160f is disposed on the apparatus front direction side. The cooling module 160f is disposed facing the cooling module 160r in a predetermined direction.

As illustrated in FIG. 11C, the cooling module 160f is disposed facing the cooling module 160r. In the present embodiment, the disposition relation of cooling modules as illustrated in FIG. 11C is referred to as facing in the sheet width direction. The fans 401r and 402r are fans on a side facing the cooling module 160f in the sheet width direction. The fans 401f and 402f are fans on a side facing the cooling module 160r in the sheet width direction. The cooling modules 160f and 160r are collectively referred to as a cooling module pair. The disposition relation of two cooling modules is not limited thereto. For example, the manner of disposition is not limited as long as the cooling modules are disposed so that a printed image can be excellently maintained in a case where all cooling modules are normally operating. In a case where two cooling modules are disposed in the sheet width direction as illustrated in FIG. 11C, all fans (401f, 401r, 402f, and 402r) of the cooling modules are preferably stopped when output from one fan among the plurality of fans has decreased.

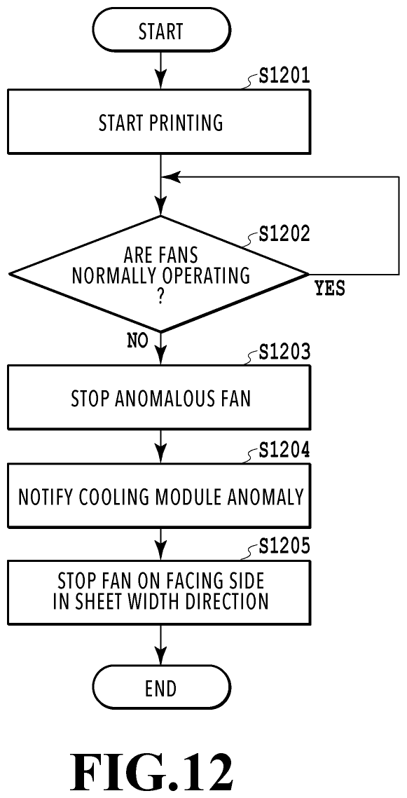

FIG. 12 is a flowchart illustrating an example of processing executed by the control unit 101 of the printing apparatus 1 according to the present embodiment. Processing executed by the CPU 220 of the control unit 101 in a case where either one of the fans of a cooling module pair is not normally operating will be described below with reference to FIG. 12.

At S1201, the CPU 220 starts printing. Thereafter, the CPU 220 proceeds to processing at S1202. At S1202, the CPU 220 determines whether the fans of the cooling modules are normally operating. The CPU 220 proceeds to processing at S1202 in a case of having determined that the fans of the cooling modules are normally operating (Yes), or proceeds to processing at S1203 in a case of having determined otherwise (No). In other words, the CPU 220 continues processing at S1202 until determining that any fan of a cooling module is not normally operating. At S1203, the CPU 220 stops any fan determined to be anomalous at S1202. For example, in a case of having determined that the fans 401f and 402f of the cooling module 160f are anomalous, the CPU 220 stops the fans. Thereafter, the CPU 220 proceeds to processing at S1204.

At S1204, the CPU 220 notifies the user of anomaly of the cooling module determined to be anomalous at S1202. Thereafter, the CPU 220 proceeds to processing at S1205. At S1205, the CPU 220 stops any fan on the facing side in the sheet width direction. Specifically, the CPU 220 stops the fans 401r and 402r in a case of having determined that the fans of the cooling module 160f are anomalous at S1202. Thereafter, the CPU 220 adds the number of cooling modules the fans of which are stopped to the number of cooling modules with decreased output, and performs the same processing as in the process at S904 in FIG. 9 or S1004 in FIG. 10 and later.

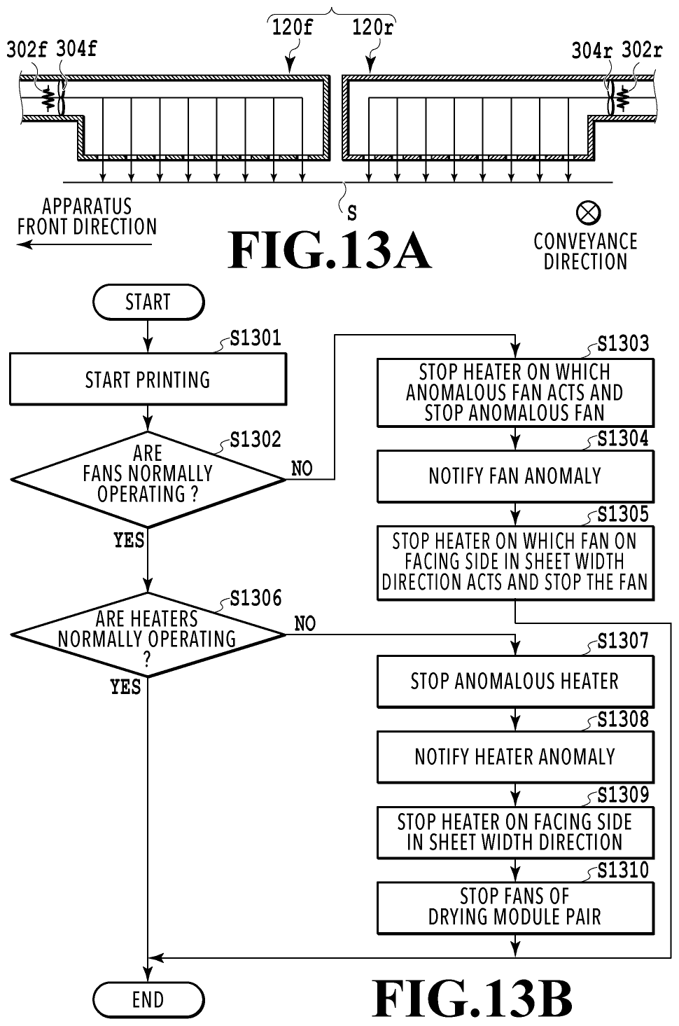

FIG. 13A is a schematic sectional view when viewed in the conveyance direction, illustrating an example in which two drying modules are disposed in the sheet width direction. In FIG. 13A, a drying module 120r and a drying module 120f are disposed. The drying modules 120r and 120f include heaters 302r and 302f and fans 304r and 304f, respectively. In FIG. 13A, the drying module 120f is disposed on the apparatus front direction side. The drying modules 120r and 120f dry ink by applying heated air from above to a printing sheet conveyed toward the back of the sheet of FIG. 13A. The disposition relation of the drying modules 120r and 120f is the same as the disposition relation of cooling modules described above with reference to FIG. 11C, and is the same in a fifth embodiment as well.

FIG. 13B is a flowchart illustrating an example of processing executed by the control unit 101 of the printing apparatus 1 according to the present embodiment. Processing executed by the CPU 220 of the control unit 101 in a case where either one of a drying module pair is not normally operating will be described below with reference to FIG. 13B.

At S1301, the CPU 220 starts printing. Thereafter, the CPU 220 proceeds to processing at S1302. At S1302, the CPU 220 determines whether the fans of the drying modules are normally operating. The CPU 220 proceeds to processing at S1306 in a case of having determined that the fans of the drying modules are normally operating (Yes), or proceeds to processing at S1303 in a case of having determined otherwise (No).

At S1303, the CPU 220 stops a heater on which a fan determined to be anomalous at S1301 acts, and stops the fan. Specifically, in a case of having determined that the fan 304f of the drying module 120f is anomalous, the CPU 220 stops the heater 302f and stops the fan 304f. Stopping of the heater of a drying module is performed to prevent what is called dry burning. Thereafter, the CPU 220 proceeds to processing at S1304. At S1304, the CPU 220 notifies the user of the anomaly of the fan. Thereafter, the CPU 220 proceeds to processing at S1305. At S1305, the CPU 220 stops a heater on the side facing the drying module including the anomalous fan in the sheet width direction, stops a fan on the facing side in the sheet width direction, and then ends the present processing.

At S1306, the CPU 220 determines whether the heaters of the drying modules are normally operating. The CPU 220 ends the present processing in a case of having determined that the heaters are normally operating (Yes), or proceeds to processing at S1307 in a case of having determined otherwise (No). At S1307, the CPU 220 stops a heater determined to be anomalous at S1306. Thereafter, the CPU 220 proceeds to processing at S1308. At S1308, the CPU 220 notifies the user of the anomaly of the heater. Thereafter, the CPU 220 proceeds to processing at S1309.

At S1309, the CPU 220 stops a heater on the side facing a drying module including the heater determined to be anomalous at S1306 in the sheet width direction. Thereafter, the CPU 220 proceeds to processing at S1310. At S1310, the CPU 220 stops the fans of the drying module pair including the drying module with the anomalous heater, and then ends the present processing. Specifically, the CPU 220 stops the fans 304f and 304r in a case of having determined that the heater 302f of the drying module 120f is anomalous.

After having ended the present processing, the CPU 220 proceeds to processing at S702 in FIG. 7 or 8 in a case of having determined that the fans and heaters of the drying modules are normally operating. In a case of having determined that either fan or heater is anomalous, the CPU 220 adds the number of stopped drying modules to the number of drying modules with decreased output, and performs the same processing as in the process at S703 in FIG. 7 or 8 and later.

According to the present embodiment, it is possible to maintain productivity while excellently maintaining the image quality within an image even in a case where output from a cooling module or a drying module has decreased.

### Fourth Embodiment

A fourth embodiment will be described below next. The entire configuration of the printing apparatus is the same as in the first to third embodiments and thus cited in the following description. Any component same as in the first to third embodiments is denoted by the same reference sign in drawings and description thereof is omitted as appropriate.

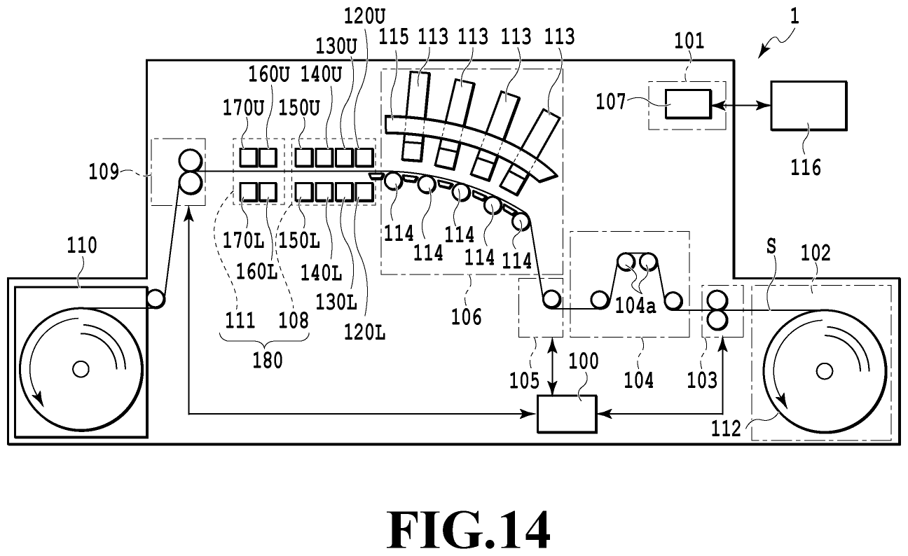

FIG. 14 is a diagram illustrating an example of the configuration of the printing apparatus according to the present embodiment. Modules disposed on the printing surface side and non-printing surface side of a printing sheet will be described below with reference to FIG. 14. As illustrated in FIG. 14, the drying modules of the drying unit 108 and the cooling modules of the cooling unit 111 heat and cool, respectively, both surfaces of the printing sheet, thereby improving heat transfer efficiency. The printing apparatus 1 includes, in the drying unit 108, drying modules 120U to 150U disposed on the printing surface side and drying modules 120L to 150L disposed on the non-printing surface side in order from the upstream side in the conveyance direction. The printing apparatus 1 also includes, in the cooling unit 111, cooling modules 160U and 170U disposed on the printing surface side and cooling modules 160L and 170L disposed on the non-printing surface side in order from the upstream side the conveyance direction.

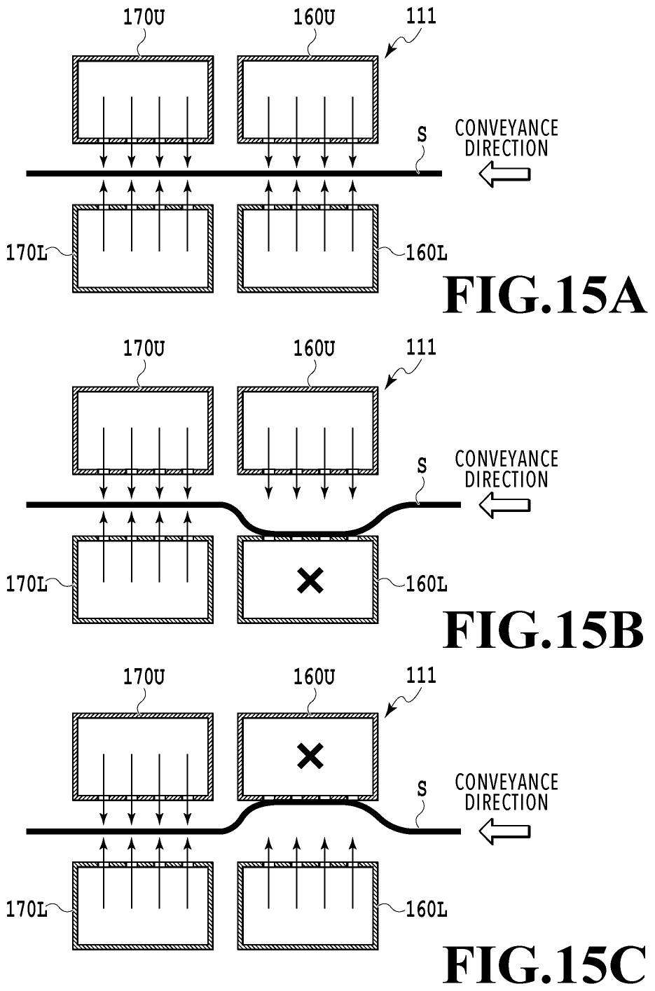

FIGS. 15A to 15C are diagrams illustrating an example of partially enlarged sections of the cooling modules 160U, 160L, 170U, and 170L when viewed in the apparatus front direction. A case where any of the cooling modules disposed on the printing surface side and the non-printing surface side is not normally operating will be described below with reference to FIGS. 15A to 15C. FIG. 15A is a diagram illustrating a case where all cooling modules are normally operating. In FIG. 15A, the cooling module 160L is disposed on the non-printing surface side of the printing sheet. The cooling module 160U is disposed facing the cooling module 160L with the printing sheet interposed therebetween. In the present embodiment, the disposition relation of cooling modules as illustrated in FIG. 15A is referred to as facing in the thickness direction. Specifically, in FIG. 15A, the cooling module 160L is a module facing the cooling module 160U in the thickness direction. The cooling module 160U is a module facing the cooling module 160L in the thickness direction. The two cooling modules 160U and 160L disposed as illustrated in FIG. 15A are referred to as a cooling module pair. This disposition relation is the same for drying modules to be described later.

FIG. 15B is a diagram illustrating a case where output from the cooling module 160L has decreased. In this case, airflow locally does not act or weakens near the cooling module 160L, and accordingly, the printing sheet receives airflow from the cooling module 160U side and deflects toward the cooling module 160L side. As a result, the printing sheet surface on the non-printing surface side is potentially damaged due to abrasion by the cooling module 160L. Simultaneously, since the distance between an air outlet of the cooling module 160U and the printing sheet increases, the heat transfer rate decreases, and as a result, a desired cooling condition is potentially not obtained. FIG. 15C illustrates a case where output from the cooling module 160U has decreased in a manner opposite to FIG. 15B. In this case, airflow from the printing surface side does not act, and accordingly, the printing sheet surface rubs against the cooling module 160U. As a result, the printing sheet and an image thereon are potentially damaged. Since the distance between a hot air outlet of the cooling module 160L and the printing sheet increases, the heat transfer rate decreases, and as a result, a desired drying condition is potentially not obtained. Furthermore, in a case where the printing sheet contacts the cooling module, friction resistance occurs during conveyance and causes unevenness in the conveyance speed. As the unevenness in the conveyance speed propagates through the printing sheet, printing becomes unstable, which potentially leads to an image defect. Thus, in a case where output from one cooling module in a cooling module pair has decreased, all cooling modules (in FIGS. 15A to 15C, 160U and 160L) are preferably stopped.

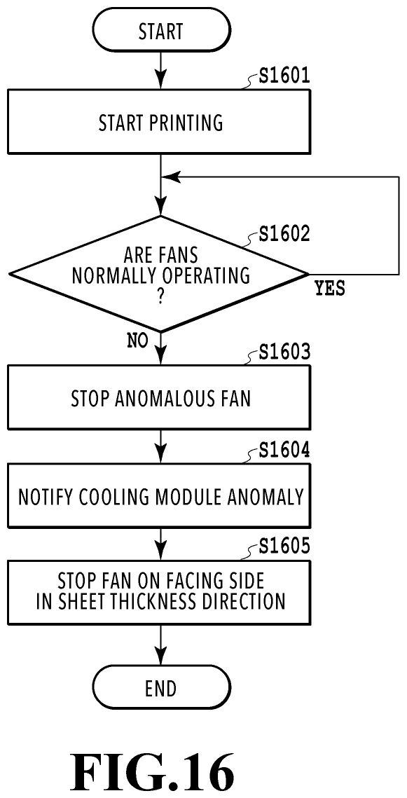

FIG. 16 is a flowchart illustrating an example of processing executed by the control unit 101 of the printing apparatus 1 according to the present embodiment. Processing executed by the CPU 220 of the control unit 101 in a case where one cooling module in a cooling module pair is not normally operating will be described below with reference to FIG. 16.

At S1601, the CPU 220 starts printing. Thereafter, the CPU 220 proceeds to processing at S1602. At S1602, the CPU 220 determines whether the fans of the cooling modules are normally operating. The CPU 220 proceeds to processing at S1602 in a case of having determined that the fans of the cooling modules are normally operating (Yes), or proceeds to processing at S1603 in a case of having determined otherwise (No). In other words, the CPU 220 continues processing at S1602 until determining that any fan of a cooling module is anomalous.

At S1603, the CPU 220 stops a fan determined to be anomalous at S1602. Thereafter, the CPU 220 proceeds to processing at S1604. At S1604, the CPU 220 notifies the user of the anomaly of the cooling module. Thereafter, the CPU 220 proceeds to processing at S1605. At S1605, the CPU 220 stops a fan on the side facing the cooling module including the anomalous fan in the thickness direction, and performs the same processing as in the process at S904 in FIG. 9 or S1004 in FIG. 10 and later.

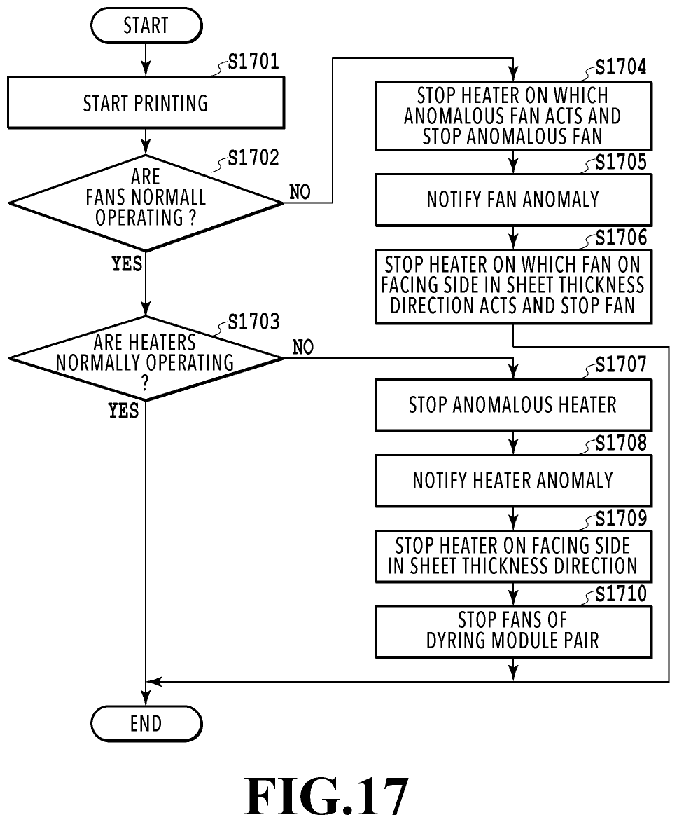

FIG. 17 is a flowchart illustrating an example of processing executed by the control unit 101 of the printing apparatus 1 according to the present embodiment. Processing executed by the control unit 101 in a case where one drying module in a drying module pair is not normally operating will be described below with reference to FIG. 17.

At S1701, the CPU 220 starts printing. Thereafter, the CPU 220 proceeds to processing at S1702. At S1702, the CPU 220 determines whether the fans of the drying modules are normally operating. The CPU 220 proceeds to processing at S1703 in a case of having determined that the fans of the drying modules are normally operating (Yes), or proceeds to processing at S1704 in a case of having determined otherwise (No).

At S1704, the CPU 220 stops a heater on which a fan determined to be anomalous at S1702 acts, and stops the fan. The drying module pair facing in the thickness direction are, for example, the drying modules 120U and 120L. In a case of having determined that the fan of the drying module 120U is anomalous, the CPU 220 stops the heater of the drying module 120U and stops the anomalous fan. Thereafter, the CPU 220 proceeds to processing at S1705. At S1705, the CPU 220 notifies the user of the anomaly of the fan. Thereafter, the CPU 220 proceeds to processing at S1706. At S1706, the CPU 220 stops a heater that acts on a fan on the side facing a drying module including the fan determined to be anomalous in the thickness direction, stops the fan, and then ends the present processing. Specifically, in a case of having determined that the fan of the drying module 120U is anomalous, the CPU 220 stops the heater of the drying module 120L and stops the fan of the drying module 120L.

At S1703, the CPU 220 determines whether the heaters of the drying modules are normally operating. The CPU 220 ends the present processing in a case of having determined that the heaters of the drying modules are normally operating (Yes), or proceeds to processing at S1707 in a case of having determined otherwise (No). At S1707, the CPU 220 stops a heater determined to be anomalous at S1703. Thereafter, the CPU 220 proceeds to processing at S1708. At S1708, the CPU 220 notifies the user of the anomaly of the heater. Thereafter, the CPU 220 proceeds to processing at S1709.

At S1709, the CPU 220 stops a heater on the side facing a drying module including the heater determined to be anomalous at S1703 in the thickness direction. Specifically, in a case of having determined that the heater of the drying module 120U is anomalous, the CPU 220 stops the heater of the drying module 120L. Thereafter, the CPU 220 proceeds to processing at S1710. At S1710, the CPU 220 stops the fans of the drying module pair including the drying module including the anomalous heater, and then ends the present processing. Specifically, in a case of having determined that the heater of the drying module 120U is anomalous, the CPU 220 stops the fan of the drying module 120U and the fan of the drying module 120L. After the present processing ends, processing of changing the conveyance speed or changing a temperature setting value is performed as described above in the first to third embodiments.

According to the present embodiment, it is possible to excellently maintain the image quality within an image on a printing sheet even in a case where output from one module in a cooling module pair and a drying module pair each disposed facing in the thickness direction has decreased.

### Fifth Embodiment

The fifth embodiment will be described next. The entire configuration of the printing apparatus is the same as in the first to fourth embodiments and thus cited in the following description. Any component same as in the first to fourth embodiments is denoted by the same reference sign in drawings and description thereof is omitted as appropriate.

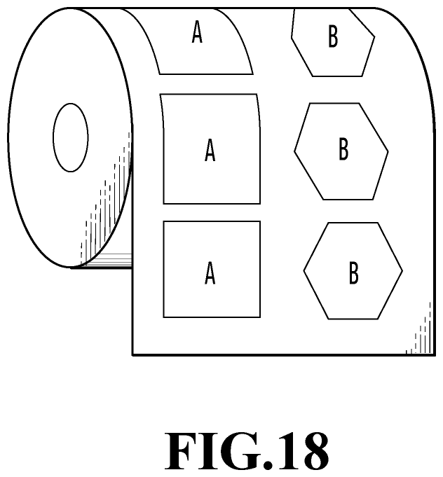

FIG. 18 is a diagram illustrating an example of a printing sheet on which images “(rectangle) A” and “(hexagon) B” are disposed in the sheet width direction within the width of the printing sheet. Depending on usage, the printing sheet illustrated in FIG. 18 is cut between the images “A” and “B” by a slitter and the images “A” and “B” are handled as two rolls.

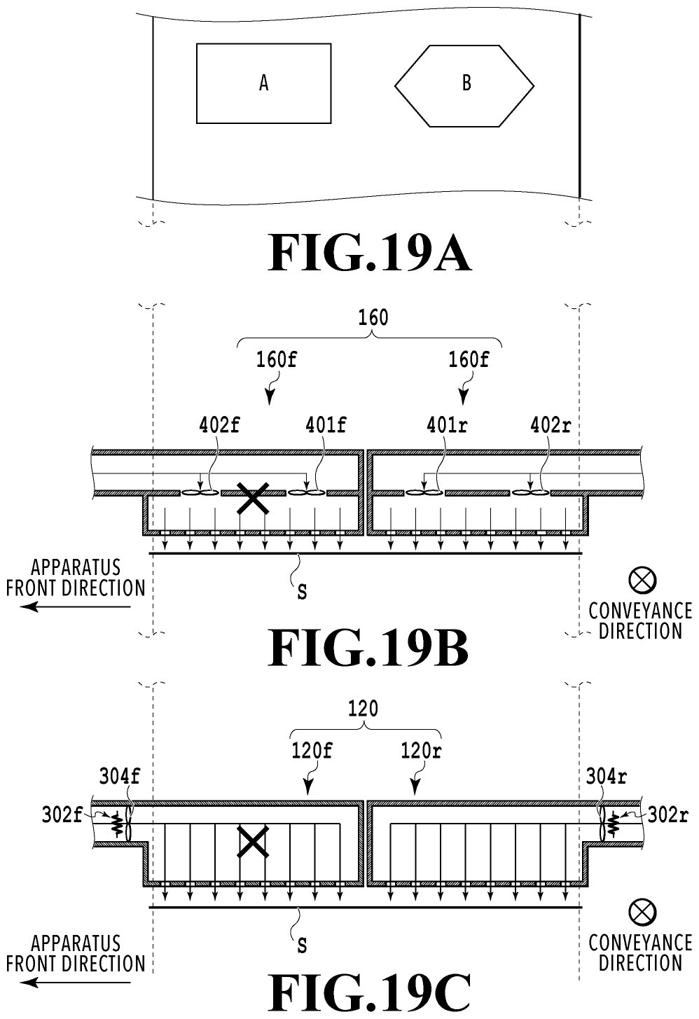

Similarly to FIGS. 11A to 11C, FIGS. 19A to 19C are diagrams schematically illustrating an example of the positional relation of the printing sheet and a drying module pair and the positional relation of the printing sheet and a cooling module pair. FIG. 19A is a diagram of the printing sheet in FIG. 18 when viewed from the printing surface side. FIG. 19B is a schematic sectional view illustrating an example of two cooling modules disposed in the sheet width direction, when viewed in the conveyance direction. FIG. 19C is a schematic section illustrating an example of two drying modules disposed in the sheet width direction, when viewed in the conveyance direction. FIGS. 19B and 19C each exemplarily illustrate a case where a module on the apparatus front direction side is anomalous (x in the drawing means output decrease).

First, in a case where the cooling module 160f is anomalous as illustrated in FIG. 19B, the user may determine to prioritize production of the roll on which the image “B” is printed and allow lowering of priority for the image quality of the image “A”. In this case, the fans (401r and 402r) of the module facing the cooling module with decreased output in the sheet width direction do not necessarily need to be stopped.

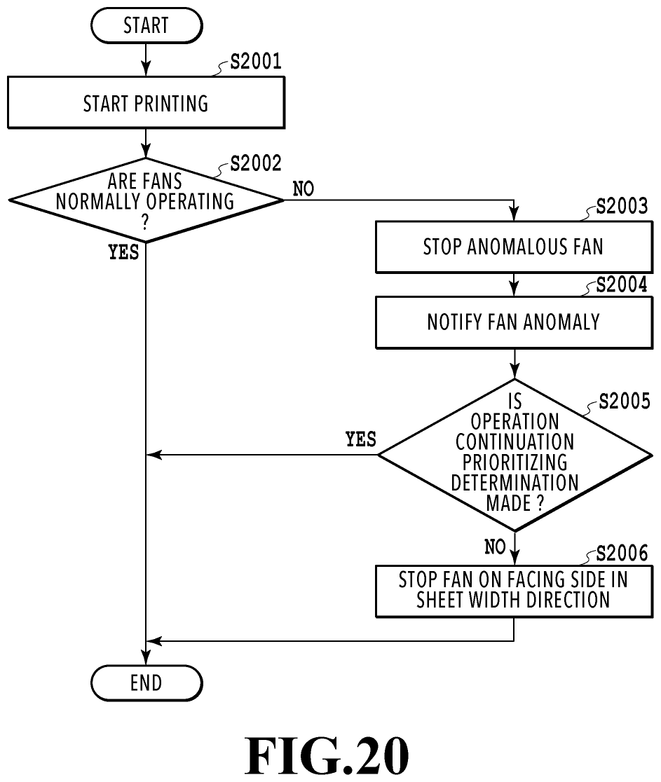

FIG. 20 is a flowchart illustrating an example of processing executed by the control unit 101 of the printing apparatus 1 according to the present embodiment. Control executed by the CPU 220 of the control unit 101 in a case where one cooling module in a cooling module pair is anomalous will be described below with reference to FIG. 20.

At S2001, the CPU 220 starts printing. Thereafter, the CPU 220 proceeds to processing at S2002. At S2002, the CPU 220 determines whether the fans of the cooling modules are normally operating. The CPU 220 ends the present processing in a case of having determined that the fans of the cooling modules are normally operating (Yes), or proceeds to processing at S2003 in a case of having determined otherwise (No). At S2003, the CPU 220 stops any fan determined to be anomalous at S2002. Thereafter, the CPU 220 proceeds to processing at S2004. At S2004, the CPU 220 notifies the user of the anomaly of the fan. Thereafter, the CPU 220 proceeds to processing at S2005.

At S2005, the CPU 220 determines whether operation continuation prioritizing determination is made. As described above, the operation continuation prioritizing determination is determination to lower the image quality of an image cooled by a fan with decreased output and prioritize the image quality of an image cooled by a normal fan. In other words, the CPU 220 determines whether to continue operation by using a cooling module with output not decreased. For this, the CPU 220 performs, on the operation unit 107, a display for selecting whether to continue operation (operation continuation prioritizing determination) and receives the determination by the user. In a case of having determined that the operation continuation prioritizing determination is made (Yes), the CPU 220 maintains drive of a fan on the side facing the cooling module including the fan with decreased output in the sheet width direction, and then ends the present processing. The CPU 220 proceeds to processing at S2006 in a case of having determined otherwise (No). At S2006, the CPU 220 stops the fan on the side facing the cooling module includes the fan determined to be anomalous at S2002 in the sheet width direction, and then ends the present processing.

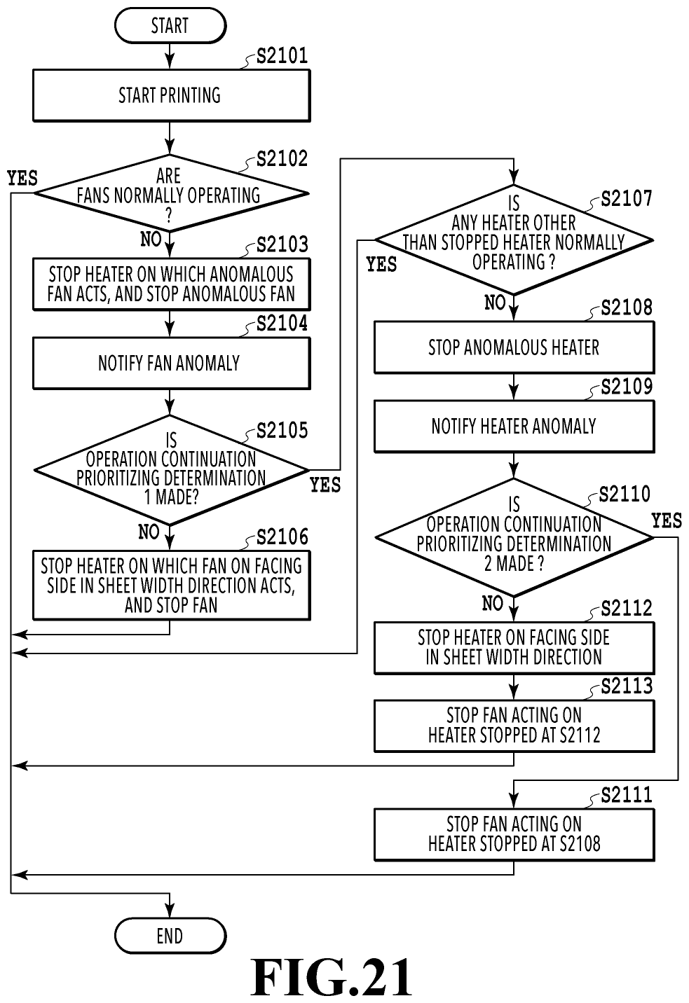

A case where the drying module 120f is anomalous as illustrated in FIG. 19C will be described next. In this case, the user may determine to prioritize production of the roll on which the image “B” is printed and allow lowering of priority for the image quality of the image “A”. In this case, the fan 304r and the heater 302r of the module facing the drying module with decreased output in the sheet width direction do not necessarily need to be stopped. FIG. 21 is a flowchart illustrating an example of processing executed by the control unit 101 of the printing apparatus 1 according to the present embodiment. Processing executed by the CPU 220 of the control unit 101 in a case where one drying module in a drying module pair is anomalous will be described below with reference to FIG. 21. As described above, FIG. 19C exemplarily illustrates a case where a module on the apparatus front direction side is anomalous. Thus, in the process described with reference to FIG. 21, it is determined whether the fan or heater of the module on the apparatus front direction side is anomalous.

At S2101, the CPU 220 starts printing. Thereafter, the CPU 220 proceeds to processing at S2102. At S2102, the CPU 220 determines whether the fans of the drying modules are normally operating. The CPU 220 ends the present processing in a case of having determined that the fans of the drying modules are normally operating (Yes), or proceeds to processing at S2103 in a case of having determined otherwise (No).

At S2103, the CPU 220 stops a heater on which a fan determined to be anomalous at S2102 acts, and stops the fan. Specifically, in a case where the fan 304f of the drying module 120f is anomalous as illustrated in FIG. 19C, the CPU 220 stops the heater 302f and stops the fan 304f. Thereafter, the CPU 220 proceeds to processing at S2104. At S2104, the CPU 220 notifies the user of the anomaly of the fan. Thereafter, the CPU 220 proceeds to processing at S2105.

At S2105, the CPU 220 determines whether operation continuation prioritizing determination 1 is made. As described above, the operation continuation prioritizing determination 1 is determination to prioritize production of the roll on which the image “B” is printed and allow lowering of priority for the image quality of the image “A”. In other words, the CPU 220 determines whether to continue operation by using a drying module with output not decreased. For this, the CPU 220 performs, on the operation unit 107, a display for selecting whether to continue operation (operation continuation prioritizing determination 1) and receives the determination by the user. The CPU 220 proceeds to processing at S2107 in a case of having determined that the operation continuation prioritizing determination 1 is made (Yes), or proceeds to processing at S2106 in a case of having determined otherwise (No).

At S2106, the CPU 220 stops a heater on which a fan on the side facing a drying module including a fan determined to be anomalous at S2102 in the sheet width direction acts, stops the anomalous fan, and then ends the present processing. Specifically, in a case of having determined that the fan 304f of the drying module 120f is anomalous, the CPU 220 stops the fan 304r and the heater 302r of the drying module 120r.

At S2107, the CPU 220 determines whether any heater other than the heater stopped at S2103 is normally operating. Specifically, in a case of having stopped the heater 302f of the drying module 120f at S2103, the CPU 220 determines whether the heater of any other drying module (not illustrated) disposed in the apparatus front direction except for the heater 302f is normally operating. The CPU 220 ends the present processing in a case of having determined that the other heater is normally operating (Yes), or proceeds to processing at S2108 in a case of having determined otherwise (No). At S2108, the CPU 220 stops the heater determined to be anomalous at S2107. Thereafter, the CPU 220 proceeds to processing at S2109. At S2109, the CPU 220 notifies the user of the anomaly of the heater. Thereafter, the CPU 220 proceeds to processing at S2110.

At S2110, the CPU 220 determines whether operation continuation prioritizing determination 2 is made. The operation continuation prioritizing determination 2 is, for example, determination of whether to continue operation in a situation where the fan 304f of the drying module 120f is anomalous and the heater of another drying module disposed in the apparatus front direction is anomalous as well. For this, the CPU 220 performs, on the operation unit 107, a display for selecting whether to continue operation (operation continuation prioritizing determination 2) and receives the determination by the user. The CPU 220 proceeds to processing at S2111 in a case of having determined that the operation continuation prioritizing determination 2 is made (Yes), or proceeds to processing at S2112 in a case of having determined otherwise (No). At S2111, the CPU 220 stops a fan acting on the heater stopped at S2108, and then ends the present processing.

At S2112, the CPU 220 stops a heater on the side facing a drying module including the heater stopped at S2103 in the sheet width direction. Specifically, in a case of having determined that the fan 304f of the drying module 120f is anomalous at S2102, the CPU 220 stops the heater 302r of the drying module 120r. Thereafter, the CPU 220 proceeds to processing at S2113. At S2113, the CPU 220 stops a fan acting on the heater stopped at S2112, and then ends the present processing. Specifically, in a case of having stopped the heater 302r of the drying module 120r at S2112, the CPU 220 stops the fan 304r of the drying module 120r.

A case where output from the fan 304 and heater 302 of the drying module 120 has decreased in the apparatus front direction is described above as an example with reference to FIG. 21. However, in reality, a drying module on the apparatus front direction side may stop due to anomaly of the fan 304, and a drying module on an apparatus back direction side may stop due to anomaly of the heater 302 as well. Furthermore, three or more modules may stop. The apparatus back direction is, for example, the direction from left to right on the sheet of FIG. 19C. Specifically, in FIG. 19C, the drying module on the apparatus back direction side is a drying module on the side where the drying module 120r is disposed. Even in such a case as described above, according to the first embodiment, control for “increasing electric power value/temperature” or “decreasing the conveyance speed” is possible by using any remaining normal drying module in a case where the user desires to continue operation of the printing apparatus (S2110). Accordingly, for example, in a case where printing of the image “B” in FIG. 18 is prioritized, printing can be continued by setting temperature or conveyance speed suitable for the image “B”. Similarly, operation can be continued with priority on printing even in a case where a plurality of cooling modules have stopped as in the second embodiment.

According to the present embodiment, operation of the printing apparatus can be continued when output from either module in a cooling module pair or a drying module pair has decreased in a case where a plurality of images are arranged on a printing sheet in the sheet width direction. Accordingly, productivity of the printing apparatus can be maintained.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to prevent decrease of apparatus productivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-150326, filed Sep. 15, 2023, which is hereby incorporated by reference herein in its entirety.

What is claimed is:

1. A printing apparatus, comprising:
at least one memory and at least one processor which function as:
a conveyance unit configured to convey a printing media on which an image is printed by a printing unit;
a detection unit configured to detect whether an anomalous module exists among a plurality of modules for drying the printing media conveyed by the conveyance unit;
a control unit configured to execute either first control for controlling output from any normal module among the plurality of modules or second control for controlling conveyance speed of the printing media in a case where the detection unit detects that an anomalous module exists; and
an obtainment unit configured to obtain temperature to be set to the normal module in a case where the detection unit detects that an anomalous module exists.

2. The printing apparatus according to claim 1, wherein the control unit controls output from the normal module disposed near the anomalous module in a case of executing the first control.

3. The printing apparatus according to claim 1, further comprising a display unit configured to perform a display for selecting either to decrease the conveyance speed of the printing media or to increase the temperature of the normal module in a case where the temperature obtained by the obtainment unit is lower than an upper temperature limit of the printing media.

4. The printing apparatus according to claim 1, wherein the control unit executes the first control in a case where the temperature obtained by the obtainment unit is lower than an upper temperature limit of the printing media.

5. The printing apparatus according to claim 1, wherein the control unit executes the second control in a case where the temperature obtained by the obtainment unit is equal to or higher than an upper temperature limit of the printing media.

6. A printing apparatus, comprising:
at least one memory and at least one processor which function as:
a conveyance unit configured to convey a printing media on which an image is printed by a printing unit;
a detection unit configured to detect whether an anomalous module exists among a plurality of modules each including a fan for cooling the printing media conveyed by the conveyance unit; and
a control unit configured to execute either first control for controlling output from any normal module among the plurality of modules or second control for controlling conveyance speed of the printing media in a case where the detection unit detects that an anomalous module exists.

7. The printing apparatus according to claim 6, further comprising an obtainment unit configured to obtain a speed increase amount of the fan included in the normal module in a case where the detection unit detects that an anomalous module exists.

8. The printing apparatus according to claim 7, wherein the control unit executes control for increasing rotation speed of the fan of the normal module in a case where the rotation speed of the fan of the normal module when the control unit executes control for increasing rotation speed of the fan based on the speed increase amount of the fan, which is obtained by the obtainment unit, is in an allowable range according to specifications of the fan.

9. The printing apparatus according to claim 6, wherein
the plurality of modules each further includes a heat exchanger configured to cool air taken in by the module, and
the control unit operates the heat exchanger of the normal module instead of executing control of output from the normal module.

10. A printing apparatus, comprising:
at least one memory and at least one processor which function as:
a conveyance unit configured to convey a printing media on which an image is printed by a printing unit;
a first module for cooling the printing media conveyed by the conveyance unit, and a second module for cooling the printing media, which is disposed facing the first module in a predetermined direction;
a detection unit configured to detect anomaly in the first module; and
a control unit configured to execute control for stopping output from the first module and output from the second module in a case where anomaly is sensed in the first module by the detection unit.

11. The printing apparatus according to claim 10, wherein the second module is disposed facing the first module in a sheet width direction of the printing media.

12. The printing apparatus according to claim 10, wherein the second module is disposed facing the first module in a thickness direction of the printing media.

13. A printing apparatus, comprising:
at least one memory and at least one processor which function as:
a conveyance unit configured to convey a printing media on which an image is printed by a printing unit;
a first module including a heater and a fan for drying the printing media conveyed by the conveyance unit, and a second module including a heater and a fan for drying the printing media, the second module being disposed facing the first module in a predetermined direction;
a detection unit configured to detect anomaly in the first module; and
a control unit configured to execute control for stopping output from the first module and output from the second module in a case where anomaly is sensed in the first module by the detection unit.

14. The printing apparatus according to claim 13, wherein the control unit executes control for stopping output from the first module and output from the second module in a case where the detection unit senses that the heater or fan of the first module is anomalous.

15. The printing apparatus according to claim 13, wherein the second module is disposed facing the first module in a sheet width direction of the printing media.

16. The printing apparatus according to claim 13, wherein the second module is disposed facing the first module in a thickness direction of the printing media.

17. A printing apparatus, comprising:
at least one memory and at least one processor which function as:
a conveyance unit configured to convey a printing media on which an image is printed by a printing unit;
a first module for cooling the printing media conveyed by the conveyance unit, and a second module for cooling the printing media, which is disposed facing the first module in a sheet width direction of the printing media;
a detection unit configured to detect anomaly in the first module;
a determination unit configured to determine whether determination for maintaining output from the second module is made; and
a control unit configured to execute control for stopping output from the first module and maintaining output from the second module in a case where the detection unit senses that the first module is anomalous and the determination unit determines that the determination is made.

18. The printing apparatus according to claim 17, wherein the control unit executes control for stopping output from the first module and the second module in a case where the detection unit senses that the first module is anomalous and the determination unit determines that the determination is not made.

19. A printing apparatus, comprising:
at least one memory and at least one processor which function as:
a conveyance unit configured to convey a printing media on which an image is printed by a printing unit;
a detection unit configured to detect whether anomaly exists in a plurality of modules for drying the printing media conveyed by the conveyance unit;
a first determination unit configured to determine, in a case where the detection unit senses that a first module among the plurality of modules is anomalous, whether determination for maintaining output from a second module among the plurality of modules is made, the second module being disposed facing the first module in a sheet width direction of the printing media; and
a control unit configured to execute control for stopping output from the first module and maintaining output from the second module in a case where the first determination unit determines that the determination is made.

20. The printing apparatus according to claim 19, further comprising a second determination unit configured to further determine whether determination for maintaining output from the second module is made in a case where the detection unit detects that a module different from the first module among the plurality of modules is anomalous.

21. The printing apparatus according to claim 20, wherein output from the module detected to be anomalous is stopped in a case where the second determination unit determines that the determination is made.

22. The printing apparatus according to claim 20, wherein output from the second module is stopped in a case where the second determination unit determines that the determination is not made.
